(19) United States
(12) Patent Application Publication
(10) Pub. No.: US 2003/0135640 A1
(43) Pub. Date: Jul. 17, 2003

(54) Method and system for group transmission and acknowledgment

(75) Inventors: Jin-Meng Ho, Plano, TX (US); Jie Liang, Plano, TX (US)

Correspondence Address: TEXAS INSTRUMENTS INCORPORATED, P O BOX 655474, M/S 3999, DALLAS, TX, 75265

(73) Assignee: Texas Instruments Incorporated, Dallas, TX

(21) Appl. No.: 10/187,928

(22) Filed: Jul. 2, 2002

Related U.S. Application Data
(60) Provisional application No. 60/349,002, filed on Jan. 14, 2002.

(51) Int. Cl. G06F 15/16

(52) U.S. Cl. 709/237

(57) ABSTRACT

A group acknowledgment scheme permits a specified subset of a previously transmitted group of data frames to be acknowledged. In accordance with the preferred embodiment of the invention, a transmitting station sends a plurality of data frames to a receiving station and requests a single group acknowledgment frame from the receiving station, rather than an individual acknowledgment after each data frame. Also, the transmitting station's group acknowledgment request frame specifies or otherwise indicates which of the previously transmitted group of frames should be acknowledged and awaited by the receiving station. The group acknowledgment may apply to the entire group of frames, some but not all of the frames or just a single frame. Further, the receiving station's group acknowledgment frame defines the size of a buffer allocated to receive the next group of frame transmissions that are linked to the same group acknowledgment scheme.

### CROSS-REFERENCE TO RELATED APPLICATIONS

This application is a non-provisional application claiming priority to provisional application Serial No. 60/349,002 filed on Jan. 14, 2002, entitled “Method and System for Burst Transmission and Acknowledgment,” the teachings of which are incorporated by reference herein.

### STATEMENT REGARDING FEDERALLY SPONSORED RESEARCH OR DEVELOPMENT

Not applicable.

### BACKGROUND OF THE INVENTION

1. Field of the Invention

The present invention generally relates to data communications. More particularly, the invention relates to a communication technique in which a receiving device acknowledges a group of data frames transmitted to it by a transmitting device. Still more particularly, the transmitting device informs the receiving device which frames in the group to acknowledge.

2. Background Information

Initially, computers were most typically used in a standalone manner. It is now commonplace for computers and other types of electronic devices to communicate with each other over a network. The ability for computers to communicate with one another has led to the creation of small networks comprising two or three computers and vast networks comprising hundreds or even thousands of computers. Networks can be set up to provide a wide assortment of capabilities. For example, networks of computers may permit each computer to share a centralized mass storage device or printer. Further, networks enable electronic mail and numerous other types of services. Networks are available in a wired configuration in which each entity on the network has a direct physical electrical connection to the network. More recently, wireless network technology has made it possible for computers and other types of electronic devices to access a network in a wireless manner.

Communication networks generally implement various agreed upon protocols and specifications to which all entities on the network adhere in order to achieve efficient and interoperable communications among the entities that may be made by different designers and manufacturers. Such protocols specify how data is to be transmitted from one point to another, the electrical characteristics of the transmission medium, etc. When a frame of data is sent by a transmitting station across the network destined for a particular receiving station, the frame may or may not be received correctly at the target receiving station. Such transmission errors may occur because of interference or noise or something more mundane, such as a loose electrical connector, a weak received signal, and the like. It is generally desirable for the transmitting station to know whether its frames are being received by the intended recipient so that all failed data can be resent, if necessary. Accordingly, many communication protocols require the receiving station to send back an acknowledgment to the transmitting station immediately following receipt of a frame. The acknowledgment generally informs the transmitting station that the frame was correctly and completely received by the receiving station. Further, the failure of the transmitting station to receive an acknowledgment at all suggests that the original data frame may not have been received by the receiving station. Alternatively, it could be that the data was received by the receiving station, but the, acknowledgment itself fell victim to some sort of transmission error. The transmitting station has no way of distinguishing the two scenarios and, in either case, will attempt to resend the data within a certain time limit if high-quality communication is desired.

The format of communication frames transmitted across a network from one point to another is generally prescribed by the applicable standard on which the network is based. Each frame typically includes overhead information, such as source and destination addresses as well as preamble and header. The amount of overhead information can be quite significant compared to the size of the data payload in the frame depending, of course, on the size of the data payload. Because of the overhead information, it is generally desirable to make each frame have more, rather than less, data, thereby resulting in a more efficient communication paradigm. However, larger frames are more prone to transmission errors than smaller frames and incur a larger time penalty if needed to be resent. Thus, on one hand, shorter frames are desirable to reduce the time penalty involved for a resend, but on the other hand, larger frames are desirable to increase the efficiency of the transmission in light of the necessary overhead information.

Transmissions from a transmitting station to a receiving station typically involve transmitting a succession of frames. In FIG. 1, a transmitting station 10 is shown transmitting a data frame 14 to a receiving station 12. The receiving station 12 then sends back an acknowledgment frame 16. FIG. 2 shows one way in which acknowledgments are implemented. In FIG. 2, a series of frame exchange sequences 20 is shown in which a transmitting station sends a plurality of (e.g., 4) data frames 22 and a receiving station responds with four acknowledgments 24, one acknowledgment following each data frame. This scheme, often referred to as “immediate” acknowledgment, is generally satisfactory, but does require an acknowledgment frame for each data frame. Acknowledgment frames require use of the transmission medium (wire or wireless) and take a finite amount of time to transmit upon receipt of the data frame. As such, a non-trivial amount of resources is spent just for the acknowledgments. During the time an acknowledgment frame is to be and being transmitted, useful data generally cannot be transmitted on the network.

A solution to this problem is the provision for a group acknowledgment frame as shown in FIG. 3. Rather than sending an acknowledgment for each of the four data frames, a group of data frames are burst transmitted in sequence as shown followed by a single acknowledgment. The acknowledgment pertains to the previous multiple data frames and is requested by the transmitting station. This type of acknowledgment scheme is called “group acknowledgment” or “burst acknowledgment.”

Group acknowledgment thus advantageously reduces the number of acknowledgment frames and the associated time intervals between the respective data and acknowledgment frames, but also creates a number of issues and/or problems that should be addressed for an effective communication scheme. For instance, it must be decided how large a burst transmission should be before a group acknowledgment is requested by the transmitting device. Incoming frames to the receiving device are temporarily placed into a buffer in the device before they are acknowledged and passed on to other logic in the receiving device for further processing. Accordingly, the size of the bursts impacts the size of the buffer in the receiving device and vice versa. In general, smaller buffers are less expensive to implement than larger buffers, but larger buffers may be necessary given the burst size used. At any rate, these issues should be considered when implementing a group acknowledgment scheme.

Another issue that should be considered when implementing a group acknowledgment scheme is the possibility that the transmitting station may, before or after transmitting a sequence of frames, drop one or more of the frames that have waited too long for reaching the target station to be useful any more. The transmitting station also includes a buffer into which all outgoing frames are stored pending transmission across the network. Often, the transmitting station will continue to store the outgoing frames in the buffer until the receiving station acknowledges correct receipt of the frames or until the buffer is full. This permits the transmitting station to quickly resend a frame that was not correctly received by the receiving station.

For one reason or another, however, the transmitting station may decide to drop one or more frames in a group of frames from its buffer even before the receiving station positively acknowledges the frames. For example, the data being transmitted may represent audio data that by its very nature is time sensitive. Once a certain period of time elapses after a frame of audio data has arrived at the transmit buffer, it may not be desirable to send or resend the frame even if it has not been received or correctly received because sending or resending the frame may only exacerbate the problem. For whatever reason, the transmitting station may discard a frame from its buffer even though it has not transmitted it at all or it has not received an acknowledgment from the receiving station.

Because of transmission errors, the receiving station may not receive one or more earlier frames when later frames are received. In many communication protocols, the receiving station passes up the received data frames from one layer or sublayer to another in the order in which they were passed down at the transmitting station. This requirement means that the receiving station's receiving logic cannot pass the correctly received frames following a missing frame on to higher level processing logic until the receiving station determines the fate of the missing frame. Instead, the receiving station will be forced to retain the subsequently correctly received frames in its temporary buffer. In a conventional group acknowledgment scheme, the transmitting station receives an acknowledgment from the receiving station. Based on the acknowledgment, the transmitting station can determine which frames were not received correctly by the receiving station. The transmitting station may decide to retransmit incorrectly received frames immediately or at a later time or not to retransmit the missing frames at all. Meanwhile, the receiving device will not know if or when the missing frame will be resent. Because the receiving station passes up frames in sequential order, this forces the receiving station to continue to buffer up all subsequently received frames until it eventually receives the missing frames or receives positive confirmation from the transmitting station that the missing frames will not be resent. This requirement generally requires the receiving station's buffer to be undesirably large and thus costly. It may also result in excessive delays in passing up correctly received frames, especially if those frames carry time sensitive data.

For example, ten frames may arrive at the transmit buffer in a particular order waiting for transfer to another station. Barring a frame drop or a transmission error, the receiving station will receive all of ten frames. A frame drop or transmission error could cause frame number 3 not to be received, or correctly received, by the receiving station. The receiving station will continue to receive and retain in its temporary buffer frames 4-10 because it has not received frame number 3 and it only passes up frames in continuous sequential order. The receiving station may send a group acknowledgment to the transmitting station following frame number 10 that indicates that all ten frames except frame number 3 were correctly received. The transmitting station may continue to send additional frames 11-20, considering that it has discarded frame 3 earlier. As such, the receiving station will have to also store frames 11-20. Thus, in this example, the receiving station's buffer must at least be large enough to accommodate 20 frames worth of data. Even worse, the receiving station may hold all the 13 received frames following the missing frame number 3 from being delivered up to the higher layer processing logic for another indefinite time interval. Alternatively, the transmitting station could inform the receiving station that frame number 3 had been dropped and should not be awaited, while continuing sending new frames. Unless the receiving station is aware of this decision, the receiving device will continue to buffer all correctly received frames following frame number 3, eventually dropping earlier correctly received frames because of buffer overflow or delaying those received frames from further processing for an unwanted time interval.

A group acknowledgment scheme that solves these problems would be highly desirable. Such a scheme would represent a significant improvement over group acknowledgment schemes known to exist today.

### BRIEF SUMMARY OF THE PREFERRED EMBODIMENTS OF THE INVENTION

The preferred embodiments of the present invention solve the problems noted above by the implementation of a group acknowledgment scheme which permits a specified subset of a previously transmitted group of data frames to be acknowledged. In accordance with the preferred embodiment of the invention, a transmitting station sends a plurality of data frames to a receiving station and requests a single acknowledgment frame from the receiving station, rather than an acknowledgment after each data frame. Further, the transmitting station's group acknowledgment request frame specifies or otherwise indicates which of the previously transmitted group of frames should be acknowledged. The group acknowledgment may apply to the entire group of frames, some but not all of the frames or just a single frame. The transmitting station may not request acknowledgement for a frame that it does not intend to transmit or retransmit, even if the frame was not received correctly by the receiving station.

Preferably, the group acknowledgment request indicates the number of previously transmitted frames starting with the group acknowledgment request frame and counting backwards in time that should be acknowledged. Once the group acknowledgment request frame is received, the receiving station generates an appropriate group acknowledgment frame containing the acknowledgment information requested by the transmitting station. With this group acknowledgment scheme, the receiving station is informed promptly as to the status of any frames that may not have been received correctly in terms of whether those frames will be sent or resent. These and other aspects of the preferred embodiments of the present invention will become apparent upon analyzing the drawings, detailed description and claims, which follow.

### BRIEF DESCRIPTION OF THE DRAWINGS

For a detailed description of the preferred embodiments of the invention, reference will now be made to the accompanying drawings in which:

FIG. 1 shows a system diagram of a transmitting station sending a communication frame to a receiving station with the receiving station sending back an acknowledgment frame;

FIG. 2 illustrates an immediate acknowledgment scheme in which the receiving station sends an acknowledgment frame after receiving each data frame;

FIG. 3 illustrates a group acknowledgment scheme in which the receiving station sends an acknowledgment after receiving a group of data frames;

FIG. 4 shows one embodiment of a preferred group acknowledgment scheme;

FIG. 5 illustrates the use of the preferred group acknowledgment scheme;

FIG. 6 is a high level system diagram of a wireless station;

FIG. 7 shows an implementation of the preferred embodiment in the content of 802.11e standard;

FIG. 8 shows another implementation of the preferred embodiment in the context of 802.11e standard; and

FIG. 9 shows a further implementation of the preferred embodiment in the content of 802.11e standard.

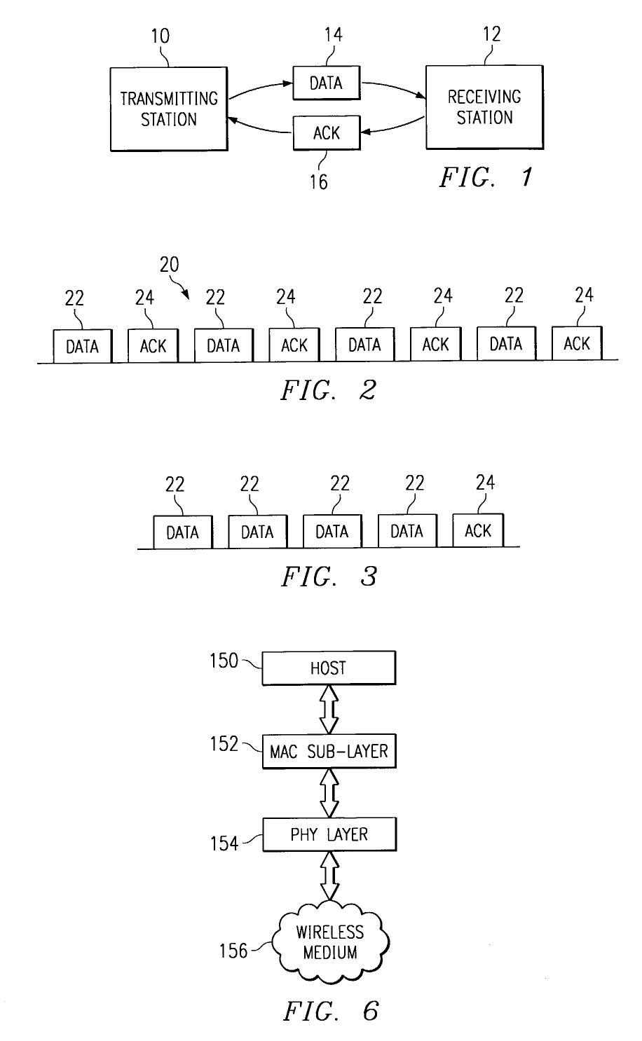

### NOTATION AND NOMENCLATURE

Certain terms are used throughout the following description and claims to refer to particular system components. As one skilled in the art will appreciate, semiconductor companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect electrical connection. Thus, if a first device couples to a second device, that connection may be through a direct electrical connection, or through an indirect electrical connection via other devices and connections. The term “frame” refers to a group of bits forming a communication unit in which information is transmitted. The term “acknowledgment” connotes both “positive acknowledgment” and “negative acknowledgment”, where “positive acknowledgment” denotes that the frame being acknowledged has been correctly received and “negative acknowledgment” denotes that the frame being acknowledged has not been received at all or without error. The terms “group acknowledgment” and “burst acknowledgment” are intended to be synonymous unless otherwise specified. To the extent that any term is not specially defined in this specification, the intent is that the term is to be given its plain and ordinary meaning.

### DETAILED DESCRIPTION OF THE PREFERRED EMBODIMENTS

The preferred embodiments of the invention solve the problems noted above by providing encoded information in the frame exchange sequence from which the receiving station can determine or infer which frames it should acknowledge and/or await. Accordingly, the receiving station will use that information to avoid acknowledging and/or awaiting those frames that the transmitting station will not send or resend anyway. Further, the receiving station's acknowledgment preferably encodes a value that indicates the size of the receiving station's temporary buffer available to storing future received frames associated with the same group acknowledgment scheme. The transmitting station advantageously can use that buffer size to determine the size of the next group of frames to be sent to that receiving station and acknowledged with the corresponding group acknowledgment scheme.

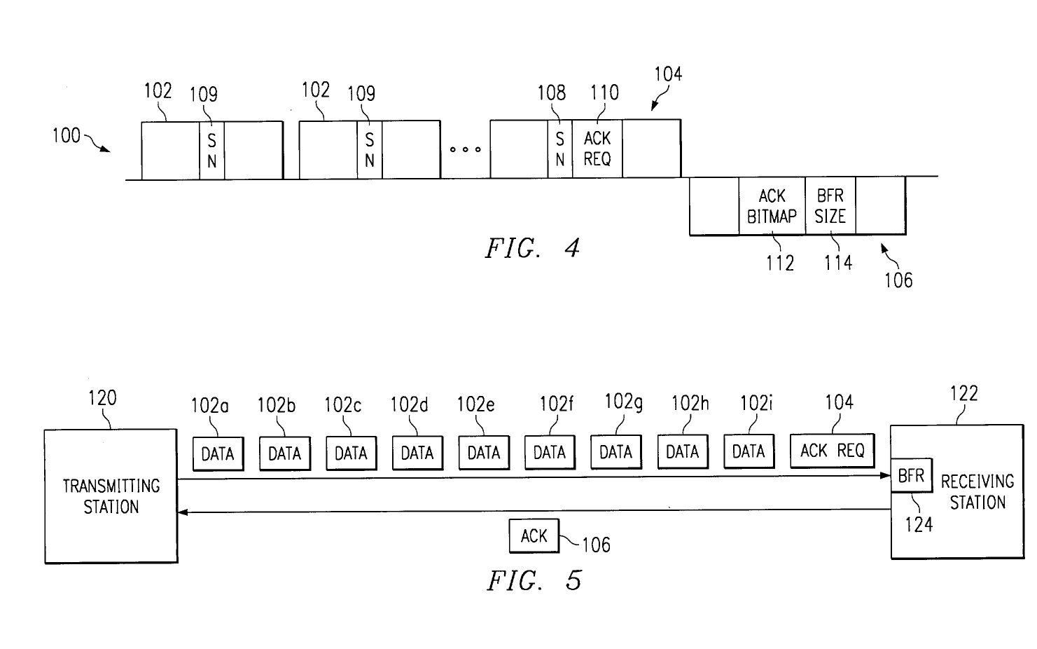

One exemplary embodiment of these principles is illustrated in FIG. 4 which shows a frame exchange sequence 100 comprising one or more data frames 102, a group acknowledgment request frame 104 and a group acknowledgment frame 106. Each data frame 102 and the group acknowledgment request frame 104 includes a number of fields of information as would be understood by those of ordinary skilled in the art. Such fields preferably include source address, destination address, transmitter address, receiver address, data (in the case of data frames 102), and other types of header and error detection and correction information. The frames 102, 104 preferably also include a sequence number field 108 into which the transmitting station stores a sequence number. The sequence number is uniquely assigned to each frame in order and permits the receiving station to ensure that the transmitted frames are processed in the correct order where required.

In accordance with the preferred embodiment of the invention, the group acknowledgment request frame 104, which preferably, but not necessarily, follows the data frames 102, includes an acknowledgement request field 110. The acknowledgement request field 110 preferably specifies or otherwise indicates which data frames 102 should be acknowledged by the receiving station. For example, the acknowledgement request field 110 may include a value that indicates the number of preceding frames including the current frame (i.e., the acknowledgment request frame 104) that may be retried by the transmitting station; all earlier data frames in the frame exchange sequence will not be retried by the transmitting station which implies that the receiving station need not acknowledge and receive those earlier frames. Thus, the receiving station acknowledges the frames, as correctly received or not, in the set to be acknowledged as indicated by the acknowledgment request field 110 and does not acknowledge the earlier frames. If any of the earlier frames were not correctly received, the receiving station preferably simply continues in some suitable fashion without those missing frames. In this case, the receiving station advantageously can release the subsequently and correctly received frames for further processing.

By way of an example, FIG. 5 shows a transmitting station 120 capable of communicating with a receiving station 122. In this example, the transmitting station has transmitted a sequence of 10 frames including nine data frames 102a-102i of data and one group acknowledgment request frame 104. The group acknowledgment request frame 104 may include a value of 7 in its acknowledgment request field 110 indicating that the previous 7 frames, including the group acknowledgment request frame, are to be acknowledged. The frames thus include frames 102d-102i and frame 104.

The value encoded into the acknowledgment request field 110 can be in accordance with any technique for providing the desired information. As explained above, the value could be the number of preceding frames to be acknowledged. Alternatively, the value could be the specific sequence number of the earliest frame in the group to be acknowledged. In the example of FIG. 5, that sequence number would be the sequence number of frame 102d.

Referring again to FIG. 4, the group acknowledgment frame 106 which is sent by the receiving station back to the transmitting station preferably includes a group acknowledgment bitmap field 112. This bitmap includes an acknowledgment for each of the frames 102 that the transmitting station indicated, via the acknowledgment request field 110, should be acknowledged. The group acknowledgment bitmap 112 includes a value associated with each data frame that is encoded to indicate whether or not the associated data frame 102 was correctly received. For example, a value of 1 may be taken to indicate that the corresponding frame was received correctly and hence indicates a positive acknowledgment to that frame, while a 0 could mean that the frame was not received yet, or not received correctly, and hence indicates a negative acknowledgment to that frame. Further, in some communication protocols, the data messages are broken down into smaller units called “fragments.” The values in the burst acknowledgment bitmap 112 could be encoded so as to permit the receiving station to acknowledge individual fragments.

As explained above, the frame exchange sequence 100 may dedicate a frame 104 for providing the group acknowledgment request information to the receiving station. Alternatively, data included in one of the data frames 102 could be included and encoded so as to provide the same type of information. This embodiment would alleviate the need to have a dedicated group acknowledgment frame 104 thereby, streamlining the frame exchange sequence while improving the channel utilization efficiency.

Referring still to FIG. 4, an additional feature of the preferred embodiment is a buffer size field 114 incorporated into the group acknowledgment frame 106. In this field, the receiving station encodes a value indicative of the amount of free space in the receiving station's buffer 124 (FIG. 5) for receiving additional frames associated with the same group acknowledgment scheme. The value, for example, may be a number of octets (8 bit values), or other data size increments, of available storage space in the buffer. The transmitting station uses this value to determine the size of future group transmissions to that receiving station. A default value for the receiving station's buffer size may be used by the transmitting station prior to the transmission of the first group acknowledgment frame.

The preferred embodiment of the group acknowledgment scheme described above provides a mechanism whereby the transmitting station can inform the receiving station when the latter need not wait for a missing frame from the former. The preferred embodiment also provides a mechanism whereby the receiving station can provide information to the transmitting station indicative of the maximum preferred size of the subsequent group of frames subject to the same group acknowledgment scheme. These features can readily be implemented in any particular communication protocol now known or later developed. The preferred embodiment can be applied to wire-based or wireless networks.

An example of a wireless network is that described by the 802.11 family of standards. The following discussion provides one suitable implementation of the principles discussed above in the context of 802.11. The 802.11 standard is officially known as the “ISO/IEC 8802-11 International Standard (ANSI/IEEE Std 802.11)” referred to herein as the “base 802.11 standard” for sake of convenience. The base 802.11 standard provides medium access control (MAC) and physical layer (PHY) specifications for telecommunications and information exchange on a wireless local area network (WLAN). The 802.11 e/D2.0a draft standard defines, on the basis of the base 802.11 standard, medium access control (MAC) enhancements for quality of service (QoS). Referring to FIG. 6, a typical wireless device (also called a “station”) includes a host 150 (e.g., notebook computer, handheld computer, PDA, etc.) which communicates with the wireless medium 156 using a MAC sublayer 152 and a PHY layer 154. The MAC sublayer 152 provides a variety of functions and services to facilitate effective wireless communications between stations. Examples of such services include data frame transmission and reception, security, and others. The host 150 uses these services to effectuate communications across a wireless network. The PHY layer 154 performs the actual transmission and reception of the MAC frames between the MAC sublayer 152 and the wireless medium 156. MAC and PHY layers are well known in the art and are described in greater detail in the 802.11 standards family which is incorporated herein by reference.

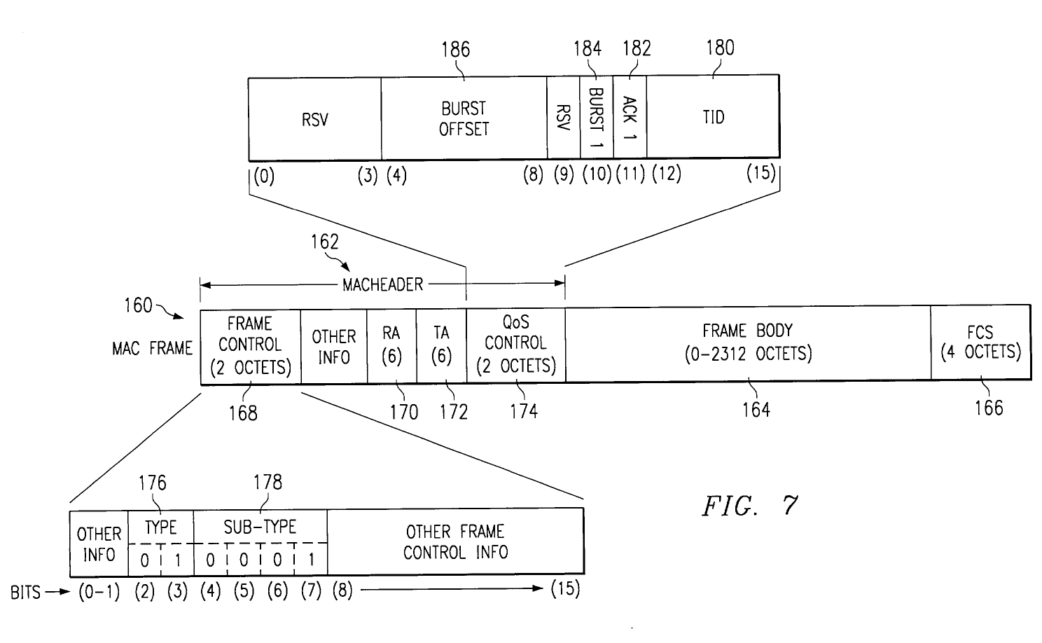

The base 802.11 standard and 802.11e/D2.0a draft standard define a structure for various frame types such as control frames, data frames, and management frames and for various communication constructs such as traffic categories and traffic streams. FIGS. 7-9 describe the use of the 802.11 and 802.11e frame structure to implement group acknowledgment and the buffer size features described above. Implementing the features described above in 802.11 e-compliant devices requires several variations from the currently adopted standard. Those variations have been implemented in what is shown in FIGS. 7-9.

Referring now to FIG. 7, a MAC frame 160 represents one embodiment of the group acknowledgment request frame 104 of FIGS. 4 and 5. MAC frame 160 is shown in FIG. 7 configured in such a way as to encode a group acknowledgment request with the identity of the frames needing to be acknowledged by the station intended to receive the frame. The address of the MAC entity that sends the group acknowledgment request is referred to as the transmitter address (TA). The address of the MAC entity that is intended to receive the burst acknowledgment request is referred to as the receiver address (RA). The base 802.11 standard defines a MAC frame as having three basic parts—a MAC header 162, a frame body 164, and a frame check sequence (FCS) 166. The FCS 166 enables error detection over the MAC header 162 and frame body 164. As shown in FIG. 7 for creating a group acknowledgment request message frame, the MAC header 162 preferably includes a frame control field 168, an RA 170, a TA 172 and a Quality of Service (QoS) control field 174. The QoS control field 174 was added to the MAC header by the 802.11 e/D2.0a draft standard. The numbers given in parentheses below the field names represent the number of “octets” comprising each field. An octet represents 8 bits. Thus, the frame control and QoS fields preferably are each 2 octets long while the RA and TA fields are each 6 octets long.

The frame control and QoS control fields 168 and 174 preferably are encoded in the manner shown in FIG. 7 to create a group acknowledgment request message indicating which frames to acknowledge. The frame control field 168 includes 16 bits of information as shown. The portions of the frame control field significant to the understanding of this embodiment include the type field 176 and sub-type field 178. In general, the type field includes 2 bits which specify whether the message type contained in the frame is a control message, management message or data message. According to a preferred embodiment of the present invention, burst acknowledgment request messages are data messages and, accordingly, bits 2 and 3 of the frame control field defining the message type are set to a value of 0 and 1, respectively. The sub-type field 178 preferably is a 4-bit field including bits 4-7 and is encoded to specify the particular subtype of a message type. A group request acknowledgment message preferably is signified by setting the sub-type bits 4-7 to a value of “0001” as shown, corresponding to the QoS Data subtype introduced by the 802.11 e/D2.0a draft standard.

The QoS control field 174 preferably encodes information by which the receiving MAC will detect the burst acknowledgment request and find which frames to acknowledge. The QoS field 174 preferably includes a traffic identifier (TID) 180 in bits 12-15, an acknowledgment bit (bit 11) 182, and a burst bit (bit 10) 184. A MAC is capable of transmitting and receiving frames belonging to more than one traffic category or traffic stream, with each traffic category or traffic stream assigned a TID value as is specified in the 802.11e/D2.0a draft standard. With the acknowledgement and burst bits set to values of 1 and 1, indicating a burst acknowledgment request, the value contents of bits 4-8 preferably are encoded to be a burst offset 186. The burst offset bits 186 are set to indicate the number of the MAC service data units (MSDUs) preceding and including the current frame that may be sent or resent sometimes after the burst acknowledgment message by the transmitting station for the MSDUs identified by the TID field in this frame. From this value, the sequence number can readily be calculated of the earliest MSDU to be acknowledged and received.

Referring now to FIG. 8, a MAC frame 190 represents another embodiment of the group acknowledgment request frame 104 of FIGS. 4 and 5, by which the group acknowledgment request frame is a control frame. Significant to the understanding of this embodiment are again the type field 176 and sub-type field 178, as well as the frame body portion 192. Accordingly, the type bits 2 and 3 of the frame control field are set to a value of 1 and 0, respectively, whereas the subtype bits 4-7 are set to a value of “0001” as shown, which is reserved, i.e., unused, by the base 802.11 standard.

The frame body portion 192 preferably contains a 2-octet earliest sequence control field 196 and a 1-octet traffic identifier (TID) field 198. The earliest sequence control field 196 specifies the sequence number and fragment number of the earliest frame that need be acknowledged and received by the receiving station for the traffic category or traffic stream identified by the TID in the TID field 198. The TID field 198 contains the aforementioned TID value in bits 0-3 and reserved bits 4-7.

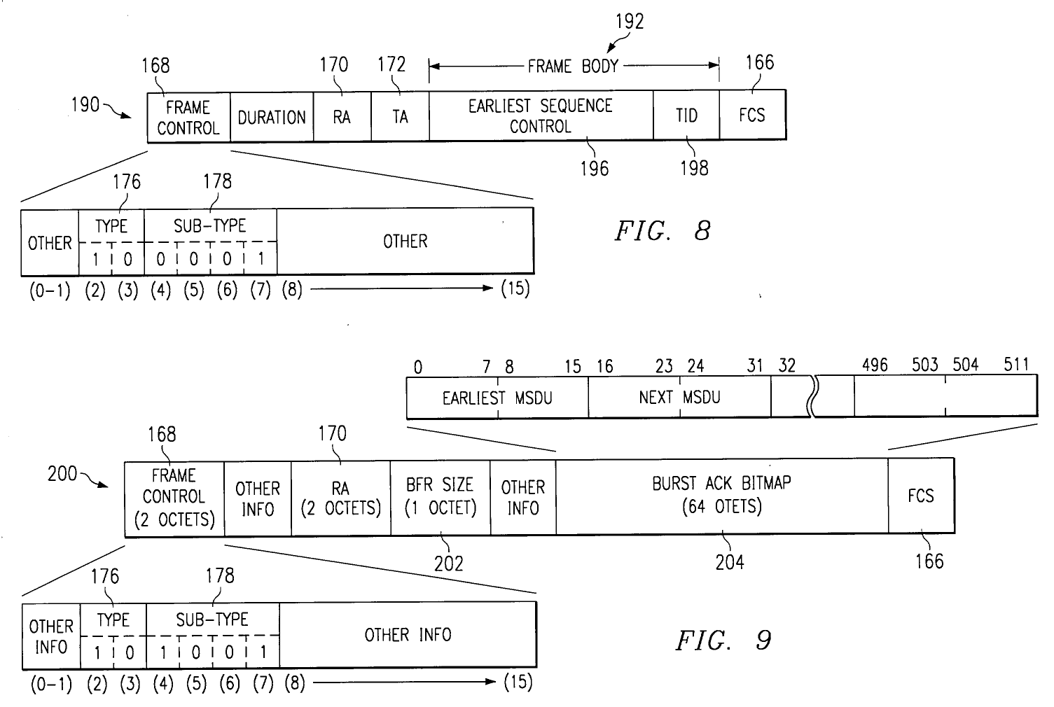

Once the receiving MAC receives the group acknowledgment request frame 160 or 190 described in FIGS. 7 and 8, respectively, the receiving MAC preferably sends back a group acknowledgment frame. One suitable implementation of a group acknowledgment frame is shown in FIG. 9. As shown, group acknowledgment frame 200 has, a structure somewhat similar, but not identical, to that of the group acknowledgment request frame 190 of FIG. 8. The burst acknowledgment frame 200 preferably includes a frame control field 168, an RA field 170, a buffer size field 202, a burst acknowledgement bitmap field 204 and an FCS field 166. The frame control field 168 is encoded similar to that of FIG. 8, but the value of the sub-type field is changed to a value of “1001” to specify that the message contained in the frame contains group acknowledgment information. This sub-type was also reserved by the base 802.11 standard. The RA field 170 preferably contains the address of the MAC entity to receive the burst acknowledgment information, which is the address of the MAC entity that requested the burst acknowledgment. Thus, the value of the RA field 170 in the burst acknowledgment frame 190 is copied from the TA field of the immediately previous burst acknowledgment request frame 160 or 190.

The burst acknowledgment information is contained in field 204. This field preferably dedicates 2 octets for each MSDU to be acknowledged as specified in the burst offset field 186 of the group acknowledgment request frame 160 or indicated via the earliest sequence control field 196 of the group acknowledgment request frame 190. The base 802.11 standard allows an MSDU to be transmitted as a number of (up to a maximum number of 16) MAC frames each containing a fragment of the MSDU. Two octets comprises 16 bits and each bit indicates whether a corresponding fragment of the MSDU is received. For example, a value of “1” could be set to mean that the fragment was received correctly, while a value of “0” could be set to mean that the fragment was never or incorrectly received. The first two octets (bits 0 to 15) correspond to the earliest MSDU referenced by the burst offset field 186 or the sequence number in the earliest sequence control field 196. Each subsequent pair of octets corresponds to a subsequent MSDU as shown.

Referring still to FIG. 9, the buffer size field 202 indicates the size of the acknowledging station's temporary buffer (which would be part of the acknowledging station's MAC sublayer) that is allocated to receive the next group of frames linked to the group acknowledgment for the traffic category or traffic stream from the acknowledged station to the acknowledging station. The traffic category or traffic stream is specified by the same TID as contained in the previous group acknowledgment request frame 160 or 190 sent from the acknowledged station to the acknowledging station. That field preferably is 1 octet in length and indicates the available buffer size in units of 1K octets (1K=1024).

The preferred group acknowledgment scheme described above thus solves the problems noted above by informing a receiving station as to which frames in a group to acknowledge. Further, the receiving station can inform the transmitting station as to its buffer size so that the transmitting station can set the group transmissions to an appropriate size.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A group acknowledgment method, comprising:
(a) receiving from a transmitting device a plurality of data frames comprising a group;
(b) receiving an acknowledgment request from the transmitting device for an acknowledgment of some, or all, of the frames in the group; and
(c) transmitting a group acknowledgment to the transmitting device indicating whether each of the frames for which an acknowledgment was requested in (b) was correctly received.

2. The method of claim 1 wherein the acknowledgment request in (b) includes a value indicative of the number of frames preceding the acknowledgment request which the receiving device is requested to acknowledge and await.

3. The method of claim 1 wherein the acknowledgment request in (b) includes a value indicative of the earliest frame which, and each frame that follows up to the acknowledgment request the receiving device is requested to acknowledge and await.

4. The method of claim 1 wherein the group acknowledgment in (c) further includes a value indicative of a size of a buffer into which the data frames in (a) are stored.

5. The method of claim 1 wherein the group acknowledgment in (c) further includes a value indicative of an amount of free space in a buffer into which the data frames in (a) are stored.

6. The method of claim 1 wherein the acknowledgment request is contained in a dedicated frame.

7. The method of claim 1 wherein the group acknowledgment request is contained in one of the data frames.

8. A group acknowledgment method, comprising:
(a) receiving from a transmitting device a plurality of data frames comprising a group;
(b) receiving an acknowledgment request from the transmitting device for an acknowledgment of one or more frames in the group; and
(c) transmitting a group acknowledgment to the transmitting device indicating an amount of free space in a buffer into which the data frames in (a) are stored.

9. The method of claim 8 wherein the acknowledgment request received in (b) specifies that some, or all, of the frames in the group are to be acknowledged and awaited by the receiving device.

10. The method of claim 8 wherein the group acknowledgment transmitted in (c) indicates whether each of the frames for which an acknowledgment was requested in (b) was correctly received.

11. The method of claim 8 wherein the acknowledgment request in (b) includes a value indicative of the number of frames preceding the acknowledgment request which the receiving device is requested to acknowledge and await.

12. The method of claim 8 wherein the acknowledgment request in (b) includes a value indicative of the earliest frame which and each frame that follows up to the acknowledgment request the receiving device is requested to acknowledge and await.

13. A group acknowledgment method, comprising:
(a) transmitting a plurality of data frames comprising a group to a receiving device;
(b) transmitting an acknowledgment request for an acknowledgment of some, or all, of the frames in the group; and
(c) receiving a group acknowledgment from the receiving device indicating whether each of the frames for which an acknowledgment was requested in (b) was correctly received.

14. The method of claim 13 wherein the acknowledgment request in (b) includes a value indicative of the number of frames preceding the acknowledgment request which the receiving device is requested to acknowledge and await.

15. The method of claim 13 wherein the acknowledgment request in (b) includes a value indicative of the earliest frame which and each frame that follows up to the acknowledgment request the receiving device is requested to acknowledge and await.

16. The method of claim 13 wherein the group acknowledgment in (c) further includes a value indicative of a size of a buffer into which the data frames in (a) are stored in the receiving device.

17. The method of claim 13 wherein the group acknowledgment in (c) further includes a value indicative of an amount of free space in a buffer into which the data frames in (a) are stored in the receiving device.

18. A group acknowledgment method, comprising:
(a) transmitting a plurality of data frames comprising a group to a receiving device;
(b) transmitting an acknowledgment request for an acknowledgment of one or more frames in the group; and
(c) receiving a group acknowledgment indicating an amount of free space in a buffer in the receiving device into which the data frames in (a) are stored.

19. The method of claim 18 wherein the acknowledgment request transmitted in (b) specifies that some, or all, of the frames in the group are to be acknowledged and awaited by the receiving device.

20. The method of claim 18 wherein the group acknowledgment received in (c) indicates whether each of the frames for which an acknowledgment was requested in (b) was correctly received.

21. The method of claim 18 wherein the acknowledgment request in (b) includes a value indicative of the number of frames preceding the acknowledgment request which the receiving device is requested to acknowledge and await.

22. The method of claim 18 wherein the acknowledgment request in (b) includes a value indicative of the earliest frame which and each frame that follows up to the acknowledgment request the receiving device is requested to acknowledge and await.

23. A group acknowledgment method, comprising:
(a) transmitting a plurality of data frames comprising a group from a transmitting device to a receiving device;
(b) transmitting an acknowledgment request to the receiving device for an acknowledgment of some, or all, of the frames in the group;
(c) receiving none, some, or all of the data frames at the receiving device;
(d) receiving the acknowledgment request at the receiving device;
(e) transmitting a group acknowledgment from the receiving device to the transmitting device indicating whether each of the frames for which an acknowledgment was requested in (b) was correctly received; and
(f) receiving the group acknowledgment at the transmitting device.

24. The method of claim 23 wherein the acknowledgment request includes a value indicative of the number of frames preceding the acknowledgment request which the receiving device is requested to acknowledge and await.

25. The method of claim 23 wherein the acknowledgment request includes a value indicative of the earliest frame which and each frame that follows up to the acknowledgment request the receiving device is requested to acknowledge and await.

26. The method of claim 23 wherein the group acknowledgment further includes a value indicative of a size of a buffer into which the data frames in (a) are stored.

27. The method of claim 23 wherein the group acknowledgment further includes a value indicative of an amount of free space in a buffer in the receiving device into which the data frames received in (c) are stored.

28. A group acknowledgment method, comprising:
(a) transmitting a plurality of data frames comprising a group from a transmitting device to a receiving device;
(b) transmitting an acknowledgment request to the receiving device for an acknowledgment of at least some of the frames in the group;
(c) receiving none, some, or all of the data frames at the receiving device;
(d) receiving the acknowledgment request at the receiving device;
(e) transmitting a group acknowledgment from the receiving device to the transmitting device indicating an amount of free space in a buffer in the receiving device into which the data frames received in (c) are stored; and
(f) receiving the group acknowledgment at the transmitting device.

29. The method of claim 28 wherein the acknowledgment request specifies that some, or all, of the frames in the group are to be acknowledged and awaited by the receiving device.

30. The method of claim 28 wherein the group acknowledgment transmitted in (e) indicates whether each of the frames for which an acknowledgment was requested was correctly received.

31. The method of claim 28 wherein the acknowledgment request transmitted in (b) includes a value indicative of the number of frames preceding the acknowledgment request which the receiving device is requested to acknowledge and await.

32. The method of claim 28 wherein the acknowledgment request transmitted in (b) includes a value indicative of the earliest frame which and each frame that follows up to the acknowledgment request the receiving device is requested to acknowledge and await.
